(19) United States
(12) Patent Application Publication
(10) Pub. No.: US 2008/0045368 A1
(43) Pub. Date: Feb. 21, 2008

(54) POWER TRANSMISSION DEVICE

(75) Inventor: Ryuuta NISHIHARA, Yokosuka-shi (JP)

Correspondence Address: GLOBAL IP COUNSELORS, LLP, 1233 20TH STREET, NW, SUITE 700, WASHINGTON, DC, 20036-2680, US

(73) Assignee: NISSAN MOTOR CO., LTD., Yokohama (JP)

(21) Appl. No.: 11/833,356

(22) Filed: Aug. 3, 2007

(30) Foreign Application Priority Data
Aug. 15, 2006 (JP) 2006-221661
Jun. 1, 2007 (JP) 2007-147234

(51) Int. Cl. F16H 57/04

(52) U.S. Cl. 475/160

(57) ABSTRACT

A power transmission device is provided with a gear mechanism, a case, an oil pump and an oil tank. The gear mechanism is arranged to operate in coordination with a drive source. The case houses the gear mechanism and stores oil for lubricating the gear mechanism. The oil pump is arranged to operate in coordination with the drive source so as to pump the oil stored in the case to lubricate the gear mechanism. The oil tank is arranged to collect a portion of the oil pumped from the oil pump. The oil tank includes a first discharge outlet arranged to discharge the oil collected in the oil tank to the case and a second discharge outlet arranged to discharge collected oil to the case when an amount of the oil collected in the oil tank is equal to or larger than a prescribed amount.

### CROSS-REFERENCE TO RELATED APPLICATIONS

This application claims priority to Japanese Patent Application No. 2006-221661, filed on Aug. 15, 2006 and Japanese Patent Application No. 2007-147234, filed on Jun. 1, 2007. The entire disclosures of Japanese Patent Application No. 2006-221661 and Japanese Patent Application No. 2007-147234 are hereby incorporated herein by reference.

### BACKGROUND OF THE INVENTION

1. Field of the Invention

The present invention generally relates to a power transmission device. More specifically, the present invention relates to a power transmission device provided with a lubricating arrangement for lubricating a gear mechanism contained in a case of the power transmission device.

2. Background Information

A power transmission device used in a vehicle typically has a gear mechanism that is operated in coordination with a drive source (e.g., a motor) serving to drive the vehicle. The power transmission device has a case that houses the gear mechanism and that stores oil for lubricating the gear mechanism (see, for example, Japanese Laid-Open Patent Publication No. 8-105520). Japanese Laid-Open Patent Publication No. 8-105520 discloses a power transmission device that improves the lubrication efficiency at low rotational speeds and the mechanical efficiency at high rotational speeds. The power transmission device disclosed in Japanese Laid-Open Patent Publication No. 8-105520 is contrived to increase the oil level in the lower portion of the case when the vehicle is stopped or traveling at a low speed, i.e., when the gear mechanism connected to the drive source is stopped or rotating at a low speed. When the gear mechanism is stopped or rotating slowly, a mechanical oil pump driven by the gear mechanism does not pump a large amount of oil. Raising the level of the oil enables the gear mechanism to be lubricated with an oil bath and improves the lubrication efficiency. Meanwhile, when the vehicle is traveling at a high speed, i.e., when the mechanical oil pump is pumping a large amount of oil, the gear mechanism is lubricated by forced lubrication with the pumped oil and the oil level is lowered. Lowering the oil level reduces the agitation resistance of the oil against the rotating members and thereby increases the mechanical efficiency.

In view of the above, it will be apparent to those skilled in the art from this disclosure that there exists a need for an improved power transmission device. This invention addresses this need in the art as well as other needs, which will become apparent to those skilled in the art from this disclosure.

### SUMMARY OF THE INVENTION

It has been discovered that with the technology disclosed in Japanese Laid-Open Patent Publication No. 8-105520, once oil starts to accumulate in the oil tank, there is the possibility that the oil level in the bottom of the case will decrease linearly with respect to the increase in rotational speed of the oil pump until the oil tank is full.

Problems that can occur when the oil level decreases linearly with respect to increases in the rotational speed of the gear mechanism will now be explained.

If the rate at which the oil level decreases is set to be low so that sufficient lubrication can be obtained by oil bath lubrication when the rotational speed of the gear mechanism (such as when the vehicle is starting into motion), then the oil level will still be somewhat high and oil bath lubrication will continue even when the rotational speed of the gear mechanism becomes comparatively high. The oil bath lubrication is not necessary because the higher rotational speed allows sufficient lubrication to occur by means of forced lubrication from the oil pump, and there is the possibility that the gradual linear decrease of the oil level will prevent the agitation resistance from being decreased efficiently.

Conversely, if the rate at which the oil level decreases is set to be high such that the agitation resistance can be prevented from increasing as the rotational speed increases, the oil level will decrease early and there is the possibility that sufficient oil bath lubrication will not be obtained at low rotational speeds.

One object of the present invention is to provide a power transmission device having good lubrication efficiency at comparatively low rotational speeds that require oil bath lubrication and good mechanical efficiency at comparatively high rotational speeds that enable forced lubrication. Thereby achieving a good balance between lubrication efficiency and mechanical efficiency as the rotational speed of the oil pump increases.

In order to achieve the aforementioned object, a power transmission device is provided that basically comprises a gear mechanism, a case, an oil pump and an oil tank. The gear mechanism is arranged to operate in coordination with a drive source. The case houses the gear mechanism and stores oil for lubricating the gear mechanism. The oil pump is arranged to operate in coordination with the drive source so as to pump the oil stored in the case to lubricate the gear mechanism. The oil tank is arranged to collect a portion of the oil pumped from the oil pump. The oil tank includes a first discharge outlet arranged to discharge the oil collected in the oil tank to the case and a second discharge outlet arranged to discharge collected oil to the case when an amount of the oil collected in the oil tank is equal to or larger than a prescribed amount.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a simplified, schematic longitudinal cross sectional view of a power transmission device in accordance with a first embodiment of the present invention, with the cross section lying in a plane containing the center axis of the power transmission device;

FIG. 2 is a simplified, schematic transverse cross sectional view of the power transmission device illustrated in FIG. 1, with the cross section lying in a plane perpendicular to the center axis of the power transmission device;

FIG. 3(a) is a graph showing a relationship between the rotational speed of the oil pump and the oil level in the power transmission device in accordance with the first embodiment;

FIG. 3(b) is a graph showing a relationship between the rotational speed of the oil pump and the supply flow rate of the oil pumped from the oil pump in the power transmission device in accordance with the first embodiment;

FIG. 4 is a simplified, schematic transverse cross sectional view of the power transmission device in accordance with the first embodiment of the present invention, the cross section lying in a plane perpendicular to the center axis of the power transmission device;

FIG. 5 is a simplified, schematic transverse cross sectional view of a power transmission device in accordance with the first embodiment of the present invention, the cross section lying in a plane perpendicular to the center axis of the power transmission device;

FIG. 6 is a simplified, schematic transverse cross sectional view of a power transmission device in accordance with a second embodiment of the present invention, the cross section lying in a plane perpendicular to the center axis of the power transmission device;

FIG. 7(a) is a graph showing a relationship between the rotational speed of the oil pump and the oil level in a power transmission device in accordance with the second embodiment;

FIG. 7(b) is a graph showing a relationship between the rotational speed of the oil pump and the supply flow rate of the oil pumped from the oil pump in a power transmission device in accordance with the second embodiment;

FIG. 8 is a simplified, schematic transverse cross sectional view of a power transmission device in accordance with the second embodiment of the present invention, the cross section lying in a plane perpendicular to the center axis of the power transmission device;

FIG. 9(a) is a graph showing a relationship between the rotational speed of the oil pump and the oil level in a power transmission device in accordance with the second embodiment;

FIG. 9(b) is a graph showing a relationship between the rotational speed of the oil pump and the supply flow rate of the oil pumped from the oil pump; and

FIG. 10 is a simplified, schematic transverse cross sectional view of a power transmission device in accordance with a third embodiment of the present invention, the cross section lying in a plane perpendicular to the center axis of the power transmission device.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

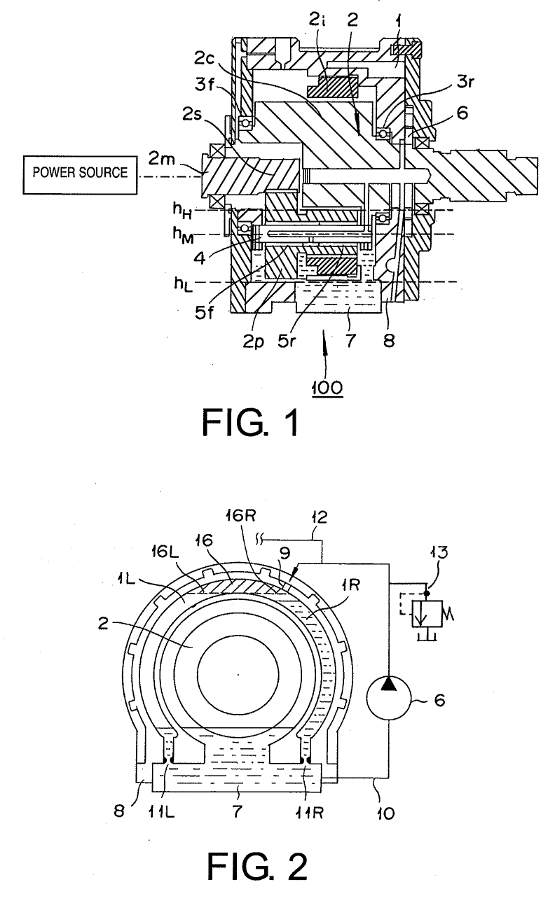

Referring initially to FIGS. 1 and 2, a power transmission device 100 is illustrated in accordance with a first embodiment of the present invention. FIG. 1 is a simplified, schematic longitudinal cross sectional view of the power transmission device 100, with the cross section lying in a plane containing the center axis of the power transmission device 100. FIG. 2 is a simplified, schematic transverse cross sectional view of the power transmission device 100, with the cross section lying in a plane perpendicular the center axis of the power transmission device 100. In this embodiment, the oil has both a lubricating effect and a cooling effect.

As shown in FIG. 1, the power transmission device 100 basically includes an oil tank 1, a gear mechanism 2, a pair of shaft bearings 3f and 3r, a pinion shaft 4, a pair of needle bearings 5f and 5r, an oil pump 6, and a case or housing 8 with a bottom portion 7. The case 8 stores lubricating oil therein. The gear mechanism 2 is housed inside the case 8. The gear mechanism 2 is operated in coordination with (connected to) a drive source. The oil pump 6 is operates in accordance with the drive source and to pump oil stored in the bottom portion 7 of the case 8 in order to forcefully lubricate the gear mechanism 2. The oil tank 1 collects a portion of the oil pumped from the oil pump 6. The drive source is a motor with a motor shaft 2m connected to the gear mechanism 2.

The gear mechanism 2 includes a planetary gear set. The planetary gear set of the gear mechanism 2 includes a sun gear 2s, an internal gear 2i, a plurality of planet pinions 2p, and a carrier 2c. The carrier 2c supports the planet pinions 2p such that they can rotate freely and holds the planet pinions 2p at an equal spacing from one another. The gear mechanism 2 serves as a motor reduction used in combination with the motor (the drive source) for driving a vehicle. The shaft 2m of the motor is connected to the sun gear 2s, the internal gear 2i is fixed to the case 8, and the output power is delivered from the carrier 2c. The carrier 2c is supported in the case 8 with the shaft bearings 3f and 3r such that it can rotate freely with respect to the case 8. Each of the planet pinions 2p is supported on the pinion shaft 4 with the needle bearings 5f and 5r such that it can rotate freely about the pinion shaft 4. The pinion shafts 4 are inserted into the carrier 2c.

The oil pump 6 is connected to the carrier 2c and thereby connected to the motor through the gear mechanism 2. As a result, the oil pump 6 operates in coordination with the motor. As seen in FIG. 2, the oil pump 6 is provided in an oil passage 10 that communicates with the bottom portion 7 of the case 8 and serves to pump oil from the bottom section 7 to an oil passage 12 and the oil tank 1 via a supply inlet 9 described later. The portions of the gear mechanism 2 requiring lubrication (bearings and meshing portions) are lubricated (by forced lubrication) with the oil pumped into the oil passage 12.

A relieve valve 13 is provided in the flow passage 10 between the oil pump 6 and the supply inlet 9 and the flow passage 12 to prevent the pressure of the oil supplied to the supply inlet 9 and the oil passage 12 from becoming higher than necessary and to reduce the load on the oil pump 6. It is preferable for the relief pressure of the relief valve 13 to be set to the lowest pressure possible while still ensuring that there is enough pressure to deliver a sufficient amount of oil through the oil passage 12 for lubricating the gear mechanism 2 during forced lubrication.

The oil tank 1 is configured and arranged in a circumferential fashion with respect to the case 8 and has a first oil tank 1R, a second oil tank 1L, and a communication passage 16. The first oil tank 1R has the supply inlet 9 positioned at an upper portion thereof and a first discharge outlet 11R arranged to be in communication with the bottom portion 7 of the case 8. Oil pumped by the oil pump 6 flows into the first oil tank 1R through the supply inlet 9. The collected oil is then discharged to the bottom portion 7 of the case 8 through the first discharge outlet 11R. The second oil tank 1L has a second discharge outlet 11L that is arranged to be in communication with the bottom portion 7 of the case 8 such that it can discharge collected oil to the bottom portion 7 of the case 8.

The communication passage 16 is arranged to join an upper portion (communication port 16R) of the first oil tank 1R to an upper portion (communication port 16L) of the second oil tank 1L (the communication passage 16 is indicated with diagonal hatching lines above a broken line in FIG. 2).

The supply inlet 9 is arranged in such a position that oil does not enter both the first oil tank 1R and the second oil tank 1L simultaneously. In this embodiment, the supply inlet 9 is provided in a position slightly offset toward the first oil tank 1R from the uppermost portion of the oil tank 1.

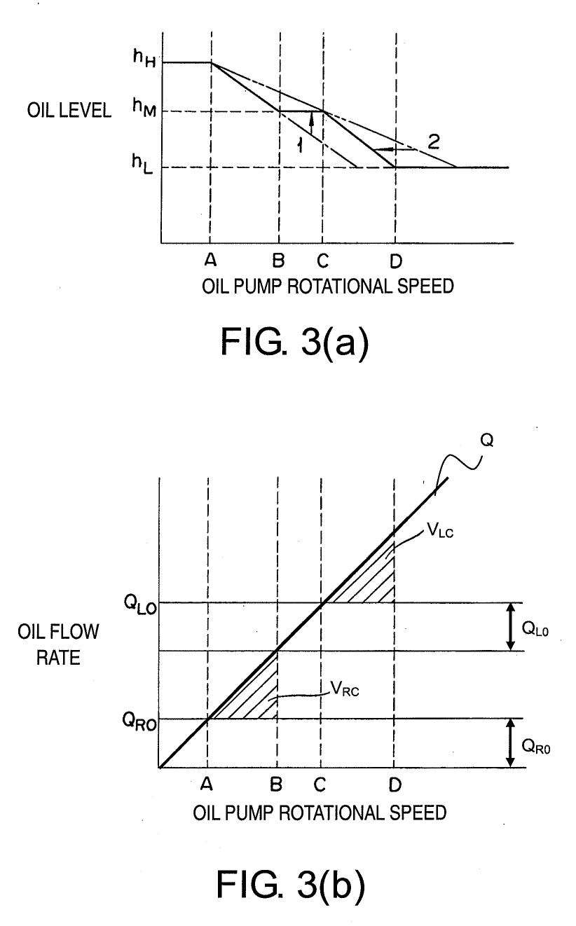

The operation of this embodiment will now be explained with reference to FIGS. 1, 2, 3(a) and 3(b). FIG. 3(a) is a graph showing a relationship between the rotational speed (rpm) of the oil pump 6 and the level of the oil stored in the bottom portion 7 of the case 8. FIG. 3 (b) is a graph showing a relationship between the rotational speed (rpm) of the oil pump 6 and the flow rate of the oil pumped by the oil pump 6.

In FIG. 3(b), the term Q_{R0} represents the oil discharge flow rate (first discharge flow rate) of the oil discharged from the first discharge outlet 11R, and the term Q_{L0} represents the oil discharge flow rate (second discharge flow rate) of the oil discharged from the second discharge outlet 11L. The term V_{RC} represents the total amount of oil that the first oil tank 1R holds when it is full. The term V_{LC} represents the total amount of oil that the second oil tank 1L holds when it is full. The Q represents the flow rate of the oil pumped by the oil pump 6 and supplied to the oil tank 1 through the supply inlet 9.

When the vehicle is in a stopped state (i.e., the oil pump is in a stopped state), the oil level is at an oil level h_{H}. The oil level h_{H} is such a level that the bearings 3f and 3r and the needle bearings 5f and 5r are t least partially submerged in the oil.

When the vehicle starts into motion, the gear mechanism 2 is driven by the motor, and thus, the oil pump 6 is also driven. Oil in the bottom portion 7 of the case 8 is pumped through the oil passage 10 and supplied to the first oil tank 1R through the supply inlet 9. At the same time, a portion of the oil passes through the branch oil passage 12 and begins to be supplied to the bearings 3f and 3r and the needle bearings 5f and 5r.

The first discharge outlet 11R is provided at the bottom end of the first oil tank 1R, and its transverse cross sectional area is set such that the oil flows into the bottom portion 7 of the case 8 at a first discharge flow rate Q_{R0}.

While the vehicle speed and the rotational speed of the gear mechanism 2 are low, the rotational speed of the oil pump 6 (which is driven by the gear mechanism 2) is low and all of the oil supplied to the first oil tank 1R is discharged to the bottom portion 7 of the case 8. Consequently, the oil level is held steady at h_{H} until the flow rate Q of the oil supplied to the first oil tank 1R exceeds the first discharge flow rate Q_{R0}.

As the vehicle speed increases and the rotational speed of the gear mechanism 2 increases, the rotational speed of the oil pump 6 also increases. When the supply flow rate Q exceeds the first discharge flow rate Q_{R0} (point A in FIG. 3), oil starts to collect in the first oil tank 1R and the oil level in the case 8 starts to fall.

When the amount of oil collected in the first oil tank 1R reaches the prescribed value V_{RC}, i.e., when first oil tank 1R becomes full of oil, the oil starts to flow through the communication passage 16 to the second oil tank 1L as seen at point B in FIG. 3(a).

The cross sectional area of the discharge outlet 11L is provided at the bottom end of the second oil tank 1L and the cross sectional area of the discharge outlet 11L is set such that the oil flows to the bottom portion 7 of the case 8 at the second discharge flow rate Q_{L0}.

Until the flow rate of the oil flowing into the second oil tank 1L (i.e., the supply flow rate Q−the first discharge flow rate Q_{R0}) exceeds the second discharge flow rate Q_{L0}, all of the oil that flows into the second oil tank 1L is discharged to the bottom portion 7 of the case 8 and the oil level of the bottom portion 7 remains steady at the level h_{M}, which is lower than the level h_{H} by the amount V_{RC} of oil collected in the first oil tank 1R. The oil level h_{M} is such a level that the pinion shaft 4 is at least partially submerged.

As the vehicle speed increases further and the flow rate of oil flowing into the second oil tank 1L (Q−QR0) exceeds the second discharge flow rate QL0 as seen at point C in FIG. 3(a), oil begins to collect in the second oil tank 1L and the oil level in the bottom portion 7 of the case 8 decreases further.

When the amount of oil collected in the second oil tank 1L reaches the amount V_{LC}, i.e., when the second oil tank 1L becomes full as seen at point D in FIG. 3(a), the oil level in the bottom portion 7 of the case 8 holds steady at the level h_{L}, which is the lowest attainable oil level. The oil level h_{L} is the oil level of the oil in the bottom portion 7 of the case 8 when the oil tank 1 is full and is below the height of the lowest portion of the gear mechanism 2.

In this embodiment, the first discharge flow rate Q_{R0} and the second discharge flow rate Q_{L0} are the same. Consequently, the rate at which the oil level declines (e.g., the slope of graph shown in FIG. 3(a)) is the same between points A and B (i.e., when oil is collecting in the first oil tank 1R) as it is between points C and D (i.e., when oil is collecting in the second oil tank 1L).

The effects of this embodiment will now be explained with reference to FIGS. 3(a) and 3(b). Consider the single-dot chain line and the double-dot chain line shown in FIG. 3(a) as comparative examples. The straight lines indicated by the single-dot chain line and the double-dot chain line illustrate examples in which the oil level decreases linearly as the rotational speed of the oil pump increases.

In the example having the faster oil level decrease rate (single-dot chain line), the oil level falls below the level h_{M} by the time the oil pump rotational speed surpasses the point B. Consequently, the oil bath-type lubrication of the needle bearings 5f and 5r ends when at the point B. However, it is necessary for the needle bearings 5f and 5r to be amply lubricated at this point because the rotational speed of the planet pinions 2p is comparatively high compared to the other rotating members (e.g., the carrier 2c, the sun gear 2s, and the oil pump 6). Since the rotational speed of the oil pump 6 (i.e., the supply flow rate Q) is low, it is not possible to obtain sufficient lubrication by forced lubrication. Consequently, the needle bearings 5f and 5r tend to be insufficiently lubricated.

In order to prevent this from occurring, it is better to continue oil bath lubrication until the needle bearings 5f and 5r can be sufficiently lubricated by forced lubrication. Since the needle bearings 5f and 5r can be sufficiently lubricated by forced lubrication when the rotational speed of the oil pump 6 (i.e., the supply flow rate Q) has surpassed the point C, the oil level needs to be held at the level h_{M} with the needle bearings 5f and 5r submerged until the rotational speed of the oil pump 6 surpasses the point C.

If the oil level decrease rate is reduced (as indicated with the double-dot chain line) in order to prevent the oil level from becoming too low before the rotational speed of the oil pump 6 surpasses point C, then a sufficient oil level will be ensured until the point C is reached but the agitation resistance will be higher and the mechanical efficiency will be degraded due to the slow decrease in the oil level.

Conversely, with this embodiment, the oil level is decreased in a step-like manner as indicated with the solid line in FIG. 3(a). A sufficient oil level is secured for the rotational speed regions that require oil bath lubrication (comparatively low rotational speeds) (see arrow 1 in FIG. 3(a)), and the oil level can be lowered quickly when the rotational speed enters a region in which forced lubrication is possible (comparatively high rotational speeds) (see arrow 2 of FIG. 3 a)).

The rotational speed region in which oil bath lubrication is necessary and the rotational speed region in which forced lubrication is possible are not always the same; they vary depending on the structure of the gear mechanism and other factors.

With this embodiment, the use of the oil tanks 1R and 1L enables the oil level inside the case 8 to be changed in a step-like manner as the rotational speed of the gear mechanism 2 increases. As result, when the rotational speed is low and the discharge flow rate from the oil pump 6 is small, oil bath lubrication can be utilized to supply a sufficient amount of lubricating oil to the bearings and meshing portions of the gears. Later, as the speed increases, the oil level can be decreased in a step-like manner while ensuring the required amount of oil exists at the positions of the bearings 3f and 3r and the pinion shaft 4. Then, when the rotational speed becomes high enough for the discharge flow rate of the oil pump 6 to be sufficient, the power transmission device switches completely to forced lubrication and rotation of the rotating members through the lubricating oil is suppressed so as to reduce the agitation resistance.

As a result, good lubrication efficiency can be achieved at comparatively low rotational speeds that require oil bath lubrication and good mechanical efficiency can be achieved at comparatively high rotational speeds that enable forced lubrication. In other words, a good balance can be achieved between lubrication efficiency and mechanical efficiency as the rotational speed of the oil pump increases.

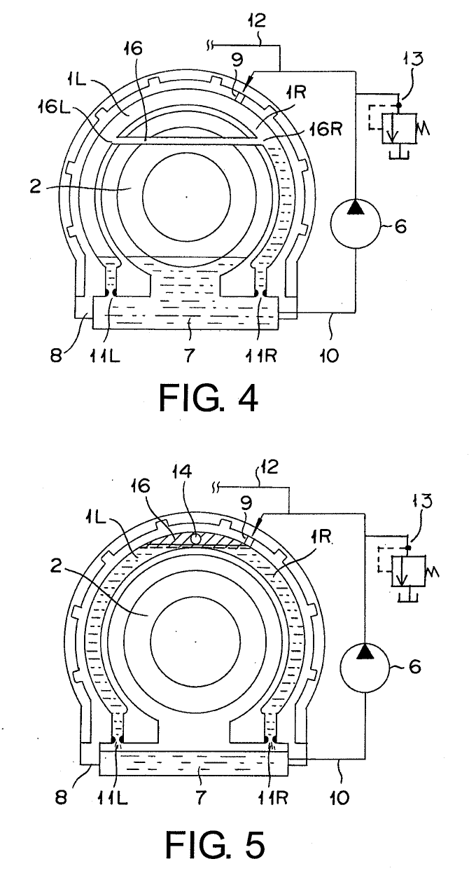

Although in the embodiment the communication passage 16 joining the first oil tank 1R and the second oil tank 1L is provided at a top portion of the oil tank 1, the position of the communication passage 16 is not limited to this position and can be set at any desired position (i.e., the communication ports can be at any desired height relative to the bottom end of the oil tank 1) (see FIG. 4). Wherever the communication passage 16 is positioned, the point B shown in FIG. 3 is reached when the oil collected in the first oil tank 1R reaches the height of the communication passage. Consequently, the volume of the first oil tank 1R and, thus, the oil level h_{M} can be adjusted by adjusting the position of the communication passage 16.

Although the embodiment presents a case in which there are two oil tanks, i.e., the first and second oil tanks 1R and 1L, it is also acceptable to have three or more oil tanks. For example, it would be acceptable to have a third oil tank and a fourth oil tank.

When three or more oil tanks are provided, the oil level can be changed in steps (stages) by providing a plurality of communication passages 16 joining the oil tanks together. The number of stages increases in accordance with the number of oil tanks and the oil level of each stage can be adjusted by adjusting the height of the communication passage 16 provided between the respective oil tanks. When several oil tanks are provided, the oil tanks can be arranged around the outer circumference of the gear mechanism 2 as shown in FIG. 2 or provided separately inside the case 8.

Additionally, when several oil tanks are provided, it is acceptable to provide a communication port 14 (equivalent to a ventilation port) for communicating with the inside of the case 8 at a position inside the oil tank that is even with or higher than the communication passage 16 (it is also acceptable for the communication port to be located in the communication passage 16) (see FIG. 5). In such a case, when the oil pump 6 is stopped due to the vehicle being stopped, the communication port 14 causes the upper portion of the oil tank 1 to be open to the atmosphere such that the oil collected in the oil tank 1 flows smoothly out of the discharge outlets 11R and 11L at the bottom end of the oil tank 1, enabling the lubricating oil to return to the bottom portion 7 of the case 8. As a result, when the vehicle starts into motion again after stopping, a high enough oil level can be ensured such that a sufficient lubricating effect can be achieved by oil bath lubrication, thereby preventing the occurrence of insufficient lubrication.

When the ring gear (internal gear) 2i is fixed to the case 8 in the manner of the gear mechanism 2 of this embodiment, vibrations of the gear mechanism 2 can be damped and the resulting noise can be decreased by arranging the oil tank 1 around the outer circumference of the ring gear 2i because the oil collected inside the oil tank 1 contributes to absorbing the vibration of the gear mechanism 2 when the vibration is transmitted to the surface of the case 8.

### Second Embodiment

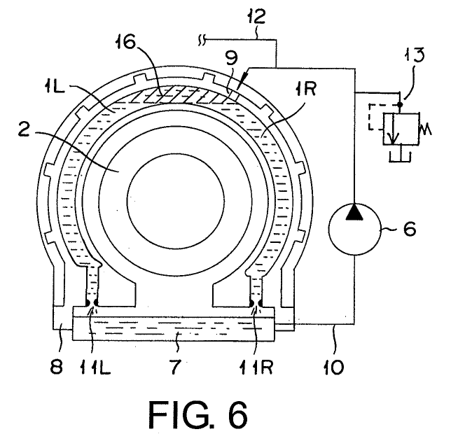

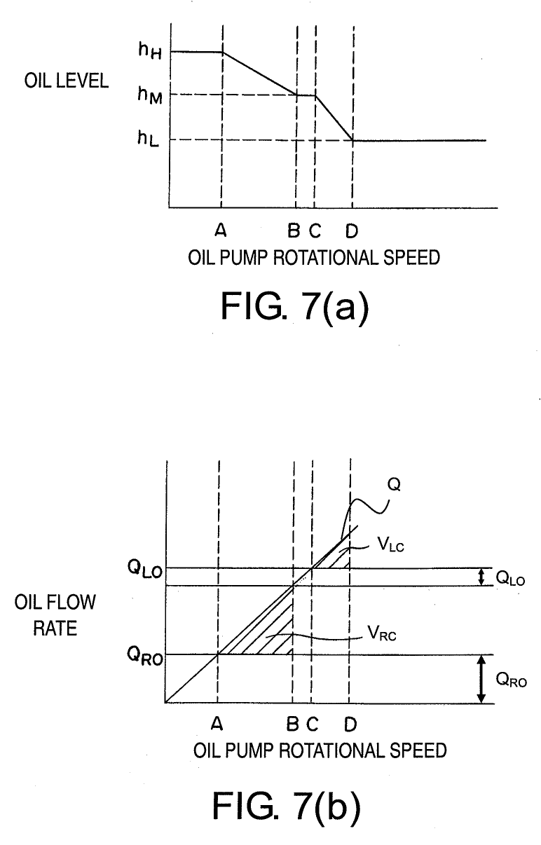

Referring now to FIGS. 6 and 7, a second embodiment of the present invention will now be explained. In view of the similarity between the first and second embodiments, the parts of the second embodiment that are identical or substantially identical to the parts of the first embodiment will be given the same reference numerals as the parts of the first embodiment. Unless otherwise stated, the parts of first and second embodiments are identical. Moreover, the descriptions of the parts of the second embodiment that are identical or substantially identical to the parts of the first embodiment may be omitted for the sake of brevity. Thus, the explanation will focus on the differences with respect to the first embodiment.

FIG. 6 is a transverse cross sectional view of a lubrication structure in accordance with the second embodiment of the present invention, the cross section lying in a plane perpendicular the center axis of the power transmission device. FIG. 7 is a graph showing a relationship between the rotational speed of the oil pump 6 and the oil level. The lubrication structure and lubricating action (effect) of this embodiment will now be explained with reference to FIGS. 6 and 7.

The power transmission device shown in FIG. 6 is configured such that the flow passage cross sectional area of the second discharge outlet 11L at the bottom end of the second oil tank 1L is smaller than the flow passage cross sectional area of the first discharge outlet 11R at the bottom end of the first oil tank 1R. Moreover, the lengths of the flow passages of the first and second discharge outlets 11R and 11L different.

As a result, the second discharge flow rate Q_{R0} is smaller than the first discharge flow rate Q_{L0} and the rate at which oil collects in the second oil tank 1L is faster than the rate at which oil collects in the first oil tank 1R. As a result, after the rotational speed of the oil pump 6 surpasses the point C, the oil level can be lowered to the level h_{L} rapidly such that oil bath lubrication is ended promptly after the rotational speed of the oil pump 6 passes the point C.

By making the cross sectional area of the second discharge outlet 11L smaller than the cross sectional area of the first discharge outlet 11R, the oil level can be decreased rapidly in a region of rotational speeds with which a sufficient lubrication effect can be obtained with forced lubrication. With this lubrication structure, the rate at which the oil level is lowered is slower in a region of rotational speeds for which oil bath lubrication is required (i.e., during the period when oil is collecting in the first oil tank 1R) and faster in a region of rotational speeds at which forced lubrication is possible (i.e., during the period when oil is collecting in the second oil tank). Thus, the rate at which the oil level decreases can be changed such that the agitation resistance can be reduced more efficiently and the mechanical efficiency can be improved.

Moreover, the first discharge outlet 11R and the second discharge outlet 11L are configured in advance such that the length of the flow passage of the second discharge outlet is longer than the length of the flow passage of the first discharge outlet 11R. As a result, the flow resistance against the discharge of oil differs between the outlets 11R and 11L and the same effect can be obtained. A difference in flow passage length can be used instead of or in combination with a difference in flow passage cross sectional area.

This embodiment achieves the effect just described by configuring the first discharge outlet 11R and the second discharge outlet 11L in advance such that the predetermined cross sectional areas of the flow passages of the first and second discharge outlets 11R and 11L are different and the predetermined lengths of the flow passages of the first and second discharge outlets 11R and 11L different. However, the same effect can also be achieved by either only making the predetermined cross sectional areas of the flow passages of the first and second discharge outlets 11R and 11L different, or by only making the predetermined lengths of the flow passages of the first and second discharge outlets 11R and 11L different.

It is also acceptable to configure the supply inlet 9 of the oil tank 1 with a choke structure comprising a tubular passage of a prescribed length and configure the first discharge outlet 11R and the second discharge outlet 11L with orifice structures that do not have any tubular length. With such a structure, when the rotational speed of the oil pump 6 is low and the oil is still at a low temperature, the oil delivered to the oil tank 1 is limited by the flow resistance of the supply inlet 9. Conversely, the oil flows out of the first and second discharge outlets 11R and 11L with little resistance due to the orifice structures thereof. In short, the process by which the oil level decreases is restricted. As a result, when the rotational speed of the oil pump 6 is low, the rate at which the oil level decreases is slower and the lubricating effect of oil bath lubrication can be obtained in a reliable manner. Additionally, since the oil temperature increases as the rotational speed of the drive source increases, the rate at which the oil level decreases can be increased as the rotational speed increases.

It is also acceptable to make the supply inlet 9, the first discharge outlet 11R, and the second discharge outlet 11L out of a shape memory alloy such that the diameters of the openings thereof vary depending on the oil temperature.

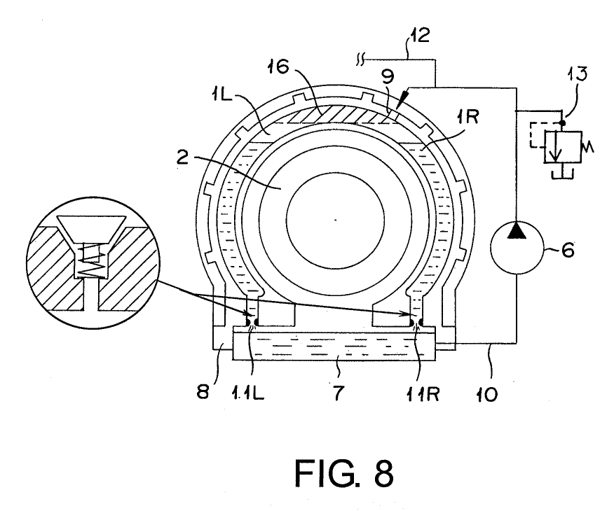

Additionally, as shown in FIG. 8, it is acceptable to contrive the first discharge outlet 11R and the second discharge outlet 11L such that the diameters of the openings thereof change depending on the pressure inside the oil tanks 1R and 1L. In the example shown in FIG. 8, a valve body spring loaded with a spring or other elastic body is provided in the second discharge outlet 11L. The elastic force (spring force) acts in the direction of raising the valve body upward such that the cross sectional area of the opening is increased. A stopper (not shown) is also provided such that the valve body will not completely close the flow passage even when it is pushed downward as far as it will go, thereby ensuring that a flow passage will exist for returning oil to the bottom portion 7 of the case 8. The power transmission device of FIG. 8 is the same as the prior embodiments except for the first and second discharge outlets 11R and 11L as explained above.

With this structure, the opening cross sectional area of the first discharge outlet 11R decreases when the internal pressure of the first oil tank 1R exceeds a prescribed pressure and the opening cross sectional area of the second discharge outlet 11L decreases when the internal pressure of the second oil tank 1L exceeds a prescribed pressure. The reduced cross sectional area causes the flow rate of the discharged oil to decrease and the rate at which oil accumulates in the respective oil tanks 1R and 1L to increase, thereby increasing the rate at which the oil level in the bottom portion 7 of the case 8 lowers.

When the vehicle speed decreases and the flow rate Q of the oil delivered from the oil pump 6 decreases, the pressure inside the oil tank 1 decreases and the opening cross sectional areas of the first discharge outlet 11R and the second discharge outlet 11L increase. Thus, when the vehicle stops, oil can be discharged rapidly to the bottom portion 7 of the case 8 and, even if the vehicle accelerates rapidly after stopping, a sufficient oil level can be secured such that insufficient lubrication does not occur. In this way, the rate at which the oil level decreases can be varied depending on the rotational speed of the oil pump 6.

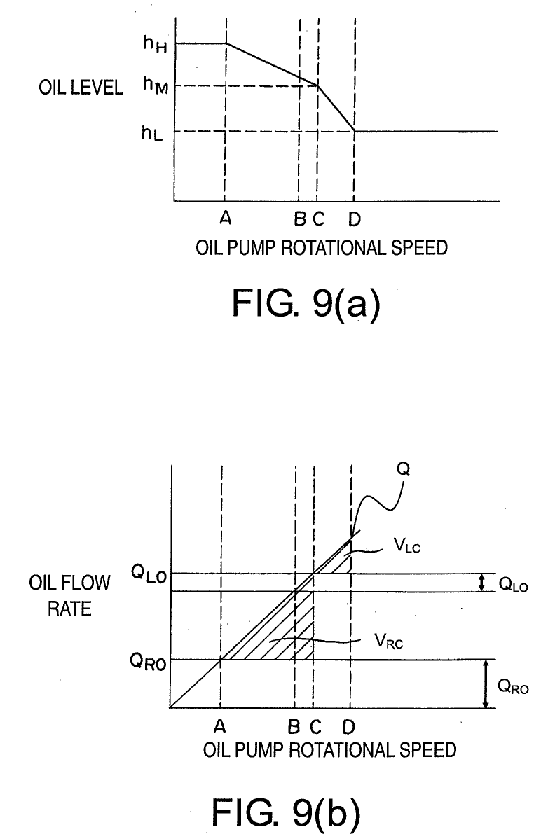

It is also acceptable to use a flow regulating valve or a solenoid valve in the supply inlet 9 and/or the discharge outlets 11R and 11L. When a controllable valve(s) such as these is used, the effects of the invention can be achieved even with a single oil tank and one or more discharge outlets. Furthermore, when a controllable valve(s) is used, the oil level can be adjusted in the step-like manner shown in FIGS. 9(a) and (b).

Also, it is acceptable for the oil pump to be a variably controlled electric pump.

### Third Embodiment

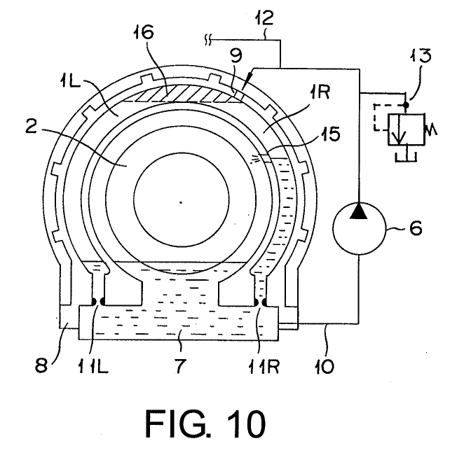

Referring now to FIG. 10, a third embodiment of the present invention will now be explained. In view of the similarity between the third embodiment and the prior embodiments, the parts of the third embodiment that are identical or substantially identical to the parts of the first embodiment will be given the same reference numerals as the parts of the first embodiment. Unless otherwise stated, the parts of first and third embodiments are identical. Moreover, the descriptions of the parts of the third embodiment that are identical or substantially identical to the parts of the first embodiment may be omitted for the sake of brevity. Thus, the explanation will focus on the differences with respect to the first embodiment.

FIG. 10 is a transverse cross sectional view of a power transmission device in accordance with the third embodiment. The cross section lies in a plane perpendicular to the center axis of the power transmission device. The lubrication structure and lubricating action (effect) of this embodiment will now be explained with reference to FIG. 10.

The power transmission device shown in FIG. 10 is provided with a third discharge outlet 15 in addition to the first discharge outlet 11R and the second discharge outlet 11L. The third discharge outlet 15 is arranged in a side wall of the first oil tank 1R in a position higher than a bottom portion of the first oil tank 1R and lower than the communication passage 16. The third discharge outlet 15 communicates with the bottom portion 7 of the case 8. Similarly to the first embodiment, lubricating oil starts being discharged from the third discharge outlet 15 to the bottom portion 7 of the case 8 when the first oil tank 1R becomes filled to the level of the third discharge outlet 15. As a result, the oil level in the bottom portion 7 can be lowered in more stages such that appropriate oil levels can be achieved for lubricating different bearings of the gear mechanism that are located at different heights, thereby preventing the occurrence of insufficient lubrication. Although the example shown in FIG. 10 has an additional discharge outlet 15 provided only on the first oil tank 1R, an additional discharge outlet can be provided on the second oil tank 1L only or on both of the oil tanks 1R and 1L. The example shown in FIG. 10 is basically based on the power transmission device shown in FIG. 2, but this embodiment is not limited to having two oil tanks. If only one oil tank is provided, the oil level can be decreased gradually by providing a plurality of discharge outlets at different heights above the bottom portion of the oil tank. The number of stages (steps) in which the oil level is lowered can be increased by increasing the number of discharge outlets, and the oil level of each stage can be adjusted by adjusting the positions (heights) of the respective discharge outlets. Additionally, the rate at which the oil level decreases during each stage can be optimized by changing the size of the corresponding discharge outlet (i.e., the cross sectional area and/or the length of the flow passage of the outlet).

As explained previously, the meaning of “step-like” (or “in stages”) regarding this invention is as illustrated in FIGS. 3, 7, and 9. “Step-like” also includes cases in which the pattern with which the oil level changes between the points A to D protrudes upward in a curve-like fashion as shown in FIG. 9 (in FIG. 9 the rate at which the oil level decreases changes at points A, C, and D).

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A power transmission device comprising:
a gear mechanism arranged to operate in coordination with a drive source;
a case housing the gear mechanism and storing oil for lubricating the gear mechanism;
an oil pump arranged to operate in coordination with the drive source so as to pump the oil stored in the case to lubricate the gear mechanism; and
an oil tank arranged to collect a portion of the oil pumped from the oil pump, the oil tank including a first discharge outlet arranged to discharge the oil collected in the oil tank to the case and a second discharge outlet arranged to discharge collected oil to the case when an amount of the oil collected in the oil tank is equal to or larger than a prescribed amount.

2. The power transmission device as recited in claim 1, wherein
the oil tank includes a first oil tank having the first discharge outlet, and a second oil tank having the second discharge outlet,
the second oil tank being arranged to discharge oil from the second discharge outlet when the amount of the oil collected in the first oil tank is equal to or above the prescribed amount.

3. The power transmission device as recited in claim 1, wherein
the second discharge outlet has a flow rate that is lower than a flow rate of the first discharge outlet.

4. The power transmission device as recited in claim 3, wherein
the second discharge outlet has a flow passage with a predetermined cross sectional area that is smaller than a predetermined cross sectional area of a flow passage of the first discharge outlet so that the flow rate of the second discharge outlet that is lower than the flow rate of the first discharge outlet.

5. The power transmission device as recited in claim 3, wherein
the second discharge outlet has a flow passage with a predetermined length that is larger than a predetermined length of a flow passage of the first discharge outlet so that the flow rate of the second discharge outlet that is lower than the flow rate of the first discharge outlet.

6. The power transmission device as recited in claim 1, wherein
at least one of the first and second discharge outlets has a variable flow rate.

7. The power transmission device as recited in claim 1, wherein
the oil tank has a third discharge outlet that is arranged higher than the first discharge outlet.

8. The power transmission device as recited in claim 1, wherein
the oil tank has an air opening communicating with an air space outside of the oil tank.

9. A power transmission device comprising:
gear means for operating in coordination with a drive source;
housing means for housing gear means and for storing oil;
oil pumping means for pumping oil stored in the housing means to lubricate the gear mechanism in response to operation of the drive source;
oil collecting means for collecting a portion of the oil pumped from the oil pumping means;
first discharge means for discharging the oil collected in the oil collecting means to the housing means; and
second discharge means for discharging collected oil to the housing means when an amount of the oil collected in the oil collecting means is equal to or larger than a prescribed amount.
